(19) United States
(12) Patent Application Publication
(10) Pub. No.: US 2004/0145572 A1
(43) Pub. Date: Jul. 29, 2004

(54) Mobile telecommunication apparatus having hidden screen

(75) Inventor: Pei-Yi Cheng, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Arima Communication Corporation, Taipei (TW)

(21) Appl. No.: 10/353,543

(22) Filed: Jan. 29, 2003

(51) Int. Cl. G09G 5/00

(52) U.S. Cl. 345/169

(57) ABSTRACT

The purpose of the present invention is to provide a mobile telecommunication apparatus having a hidden screen. The apparatus includes a housing body having a containing space and a side opening; a transmitting device disposed in the housing body; a controlling switch disposed on the housing body for controlling the transmitting device; and a screen connected to the transmitting device, wherein the screen is transmitted from the containing space to the side opening for being shown on the housing body, and transmitted from the side opening to the containing space for being hidden in the housing body.

### FIELD OF THE INVENTION

The present invention is related to a mobile telecommunication apparatus and more particularly, to a mobile telecommunication apparatus having a hidden screen.

### BACKGROUND OF THE INVENTION

With transition of times and advancement of science and technology, the mobile communication apparatus have become the essential and sophisticated apparatus for daily use. There are many kinds of the mobile communication apparatus existed around our life. With the demand increasing, the mobile communication apparatus are also integrated with other multimedia devices. The mobile communication apparatus not only includes a basic function of communication but also includes additional functions of personal digital assistant (PDA), scheduling, business card listing, entertainments, and game playing. All manufacturers compete for providing to varied products.

In the present market, there have been many types of mobile phones designed in response to the different demands of users. The mobile phones in different types are displayed in the different ways according to the information data and the serving modules. When people would like to buy a mobile phone, the interface of the mobile phone is the most important point to be thought over. The first impression on contacting with the machine will cause people to decide whether they would like to continually use it or not. The So-called interface includes the size of the displaying screen, the size of the apparatus, the method of operation and the software of the apparatus. People always think over whether the apparatus is easy to be held and operated or not.

In the early stages, the displaying screen of a mobile phone is too small to display a large number of words. Some people try to increase the size of the displaying screen for solving the above problem. Reviewing the development of mobile phones, we could figure out that the sizes of the mobile phone are becoming smaller. However if the size of a mobile phone for playing game is too small, it will be not practical. Because it is not easy to operate this kind of mobile phones and users shouldn't be satisfied with this unsuitable apparatus. Please refer to FIG. 1. It shows a mobile telecommunication apparatus according to the prior art. The prior apparatus includes a main body 11 and a displaying screen 12 disposed on the main body 11, wherein the main body 11 further includes plural button 13 for operating the mobile telecommunication apparatus. The main body 11 and the displaying screen 12 could be moved oppositely. Thereby, the plural button 13 could be hidden behind the screen 12 when the screen 12 is moved to cover the main body 11, as shown in FIG. 1(a). Certainly, the plural button 13 could be shown when the screen 12 is moved oppositely, as shown in FIG. 1(b). Although this prior mobile telecommunication apparatus provides a large displaying screen, it is still unpractical. Because of the thin main body 11, the user always complains that it can't be operated smoothly when he plays a game via the apparatus and considers that there should be other kinds of mobile telecommunication apparatus, which can be operated smoothly during game-playing.

Therefore, it is tried to rectify those drawbacks and provide a mobile telecommunication apparatus having a hiding screen by the present applicant. The screen of this invention could be shown in a first instance, and be hidden in a second instance.

### SUMMARY OF THE INVENTION

It is therefore a primary objective of the present invention to provide a mobile telecommunication apparatus having a hiding screen.

According to the present invention, the mobile telecommunication apparatus includes a housing body having a containing space and a side opening, a transmitting device disposed in the housing body, a controlling switch disposed on the housing body for controlling the transmitting device, and a screen connected to the transmitting device, wherein the screen is transmitted from the containing space to the side opening for being shown on the housing body, and transmitted from the side opening to the containing space for being hidden in the housing body.

Certainly, the side opening can be disposed on a long side of the housing body.

Preferably, the housing body further includes a button set for operating the mobile telecommunication apparatus.

Certainly, the button set can be a game button for operating games included in the mobile telecommunication apparatus.

Preferably, the housing body further includes a sub-screen for showing an incoming telegram.

Certainly, the transmitting device can be a hydraulic transmitting device.

Preferably, the mobile telecommunication apparatus further includes a pivoting device disposed between the transmitting device and the screen for rotating the screen shown out of the containing space.

Preferably, the transmitting device further includes a power device disposed in the housing body for providing a motive force, a gear set connected to the power device for transmitting the motive force, and a rack device connected to the screen and engaged with the gear for moving the screen via the motive force.

Certainly, the power device can be a motor.

According to another preferred embodiment of the present invention, the mobile telecommunication apparatus includes a housing body having a containing space and a side opening, a transmitting device disposed in the housing body; and a screen connected to the transmitting device, wherein the screen is transmitted from the containing space to the side opening for being shown thereby, and transmitted from the side opening to the containing space for being hidden thereby.

Preferably, the mobile telecommunication apparatus further includes a controlling switch disposed on the housing body for controlling the transmitting device.

Certainly, the side opening can be disposed on a long side of the housing body.

Preferably, the housing body further includes a button set for operating the mobile phone.

Certainly, the button set can be a game button for operating games included in the mobile telecommunication apparatus.

Preferably, the housing body further includes a sub-screen for showing an incoming telegram.

Certainly, the transmitting device can be a hydraulic transmitting device.

Preferably, the mobile telecommunication apparatus further includes a pivoting device disposed between the transmitting device and the screen for rotating the screen to be shown out of the containing space.

Certainly, the transmitting device can be a manual rack railway.

Preferably, the transmitting device further includes a gear set disposed in the housing body for transmitting a motive force, and a rack device connected to the screen and engaged with the gear for moving the screen via the motive force.

Preferably, the transmitting device further includes a power device disposed in the housing body and engaged with the gear set for providing the motive force.

Certainly, the power device can be a motor.

According to the preferred embodiment of the present invention, the mobile telecommunication apparatus could includes a displaying screen, a housing body having a containing space for containing the display screen, and an operating medium disposed between the displaying screen and the housing body for showing the screen on the housing body in a first instance, and hiding the displaying screen into the housing body in a second instance.

The foregoing and other features and advantages of the present invention will be more clearly understood through the following descriptions with reference to the drawings, wherein:

### BRIEF DESCRIPTION OF THE DRAWING

FIG. 1 illustrates a mobile telecommunication apparatus according to the prior art;

FIG. 2 illustrates a first preferred embodiment of a mobile telecommunication apparatus according to the present invention; and

FIG. 3 illustrates a second preferred embodiment of a mobile telecommunication apparatus according to the present invention;

FIG. 4 illustrates a third preferred embodiment of a mobile telecommunication apparatus according to the present invention; and

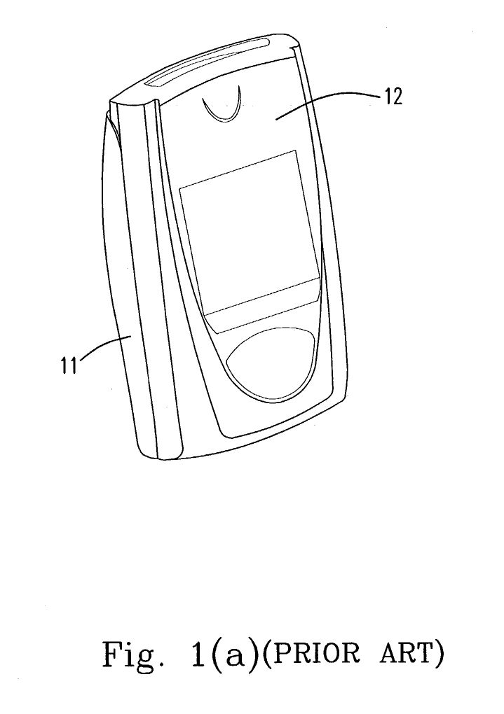

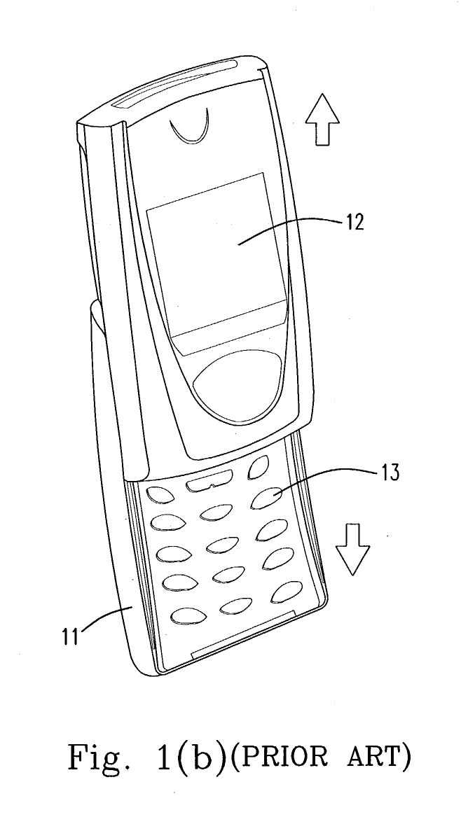

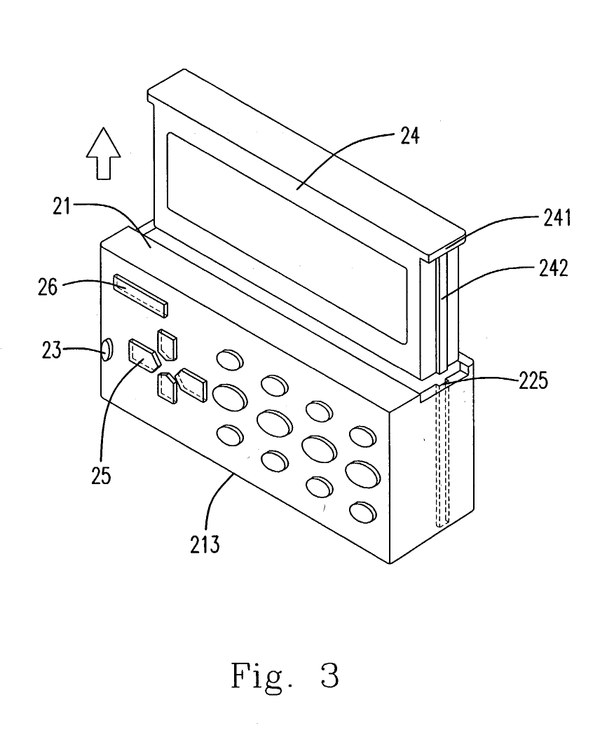

FIG. 3 illustrates a fourth preferred embodiment of a mobile telecommunication apparatus according to the present invention.

### DETAILED DESCRIPTION OF THE PREFERRED EMBODIMENTS

It is therefore a primary objective of the present invention to provide a mobile telecommunication apparatus having a hiding screen by the present applicant. The screen of this invention could be shown in a first instance, and be hidden in a second instance. When a user uses this apparatus for playing a game or multimedia, the user will be satisfied with the enjoyment of vision and smooth operation.

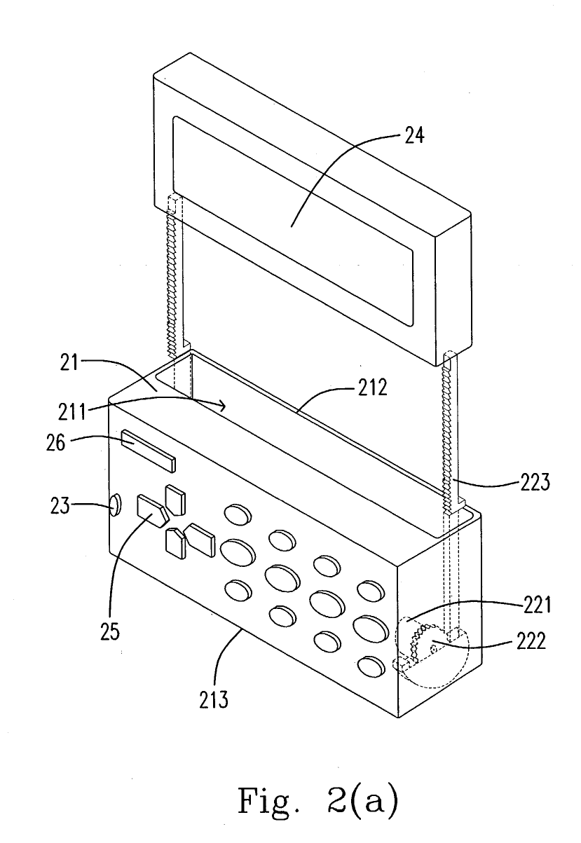

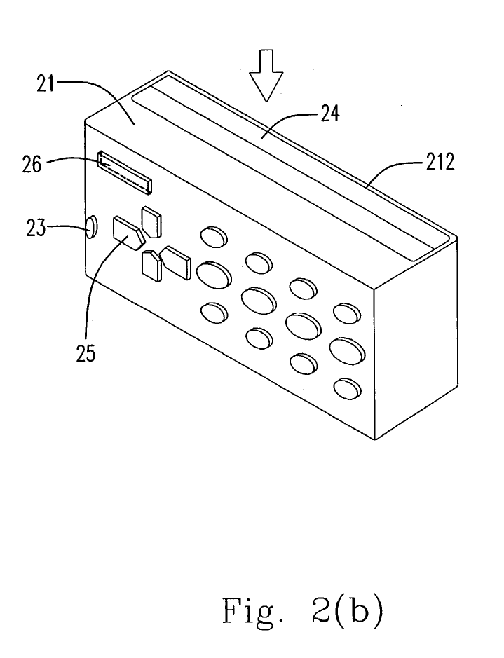

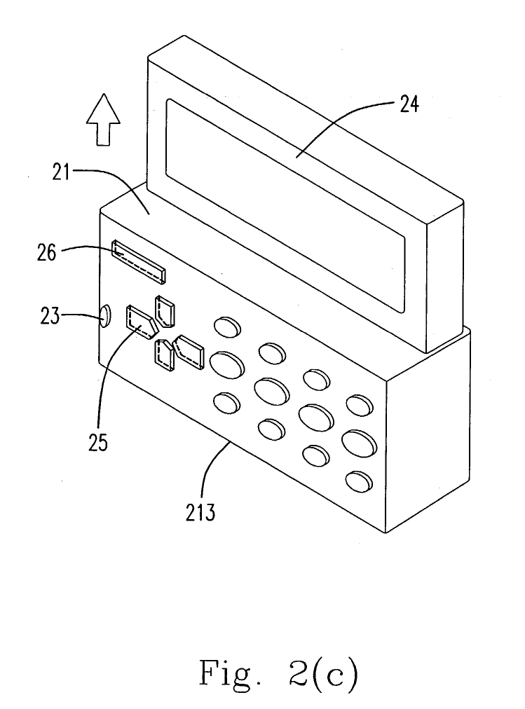

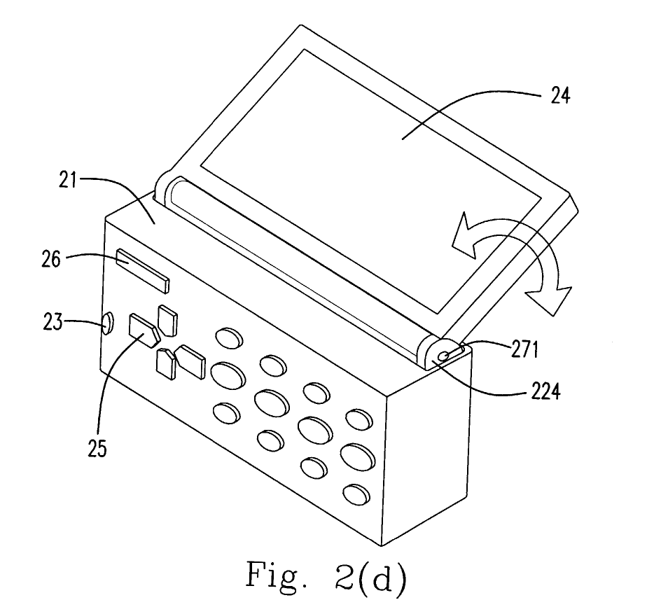

Please refer to FIG. 2. It illustrates a decomposed view of a mobile telecommunication apparatus according to the present invention. Shown in FIG. 2(a), the mobile telecommunication apparatus of the present invention includes a housing body 21 having a containing space 211 and a side opening 212, a transmitting device (including 221, 222 and 223) disposed in the containing space 211 of the housing body 21, a controlling switch 23 disposed on the housing body 21 for controlling the transmitting device, and a screen 24 connected to the transmitting device. Meanwhile the screen 24 is transmitted from the containing space 211 to the side opening 212 for being shown on the housing body 21, as shown in FIG. 2(c). Certainly, as shown in FIG. 2(b), the screen 24 also can be transmitted from the side opening 212 to the containing space 211 for being hidden in the containing space 211 of the housing body 21.

In this preferred embodiment, the side opening 212 is disposed on a long side of the housing body. Certainly, the invention needs not to be limited to the disclosed embodiment. This mobile telecommunication apparatus has a larger displaying screen and provides the enjoyment in good quality. Preferably, the housing body 21 further includes a button set 25 for operating the mobile telecommunication apparatus, and specially for operating games included in the mobile telecommunication apparatus. The controlling switch 23 disposed on the housing body 21 can also be disposed on other place according to the circuit design or the outward appearance thereof. Preferably, the housing body 21 further includes a sub-screen 26 for showing an incoming telegram while the displaying screen 24 is hidden in the housing body 21.

According to the present invention, the transmitting device can be a hydraulic transmitting device. In the above embodiment, the transmitting device further includes a power device 221 disposed in the housing body 21 for providing a motive force, a gear set 222 connected to the power device 221 for transmitting the motive force, and a rack device 223 connected to the screen 24 and engaged with the gear 222 for moving the screen via the motive force. Meanwhile, the power device 221 is a motor. Moreover, the mobile telecommunication apparatus of this preferred embodiment further includes a pivoting device 271 disposed between the transmitting device 224 and the screen 24 for rotating the screen 24 shown out of the containing space 212, as shown in FIG. 2(d).

Please refer to FIG. 3, it illustrates a second preferred embodiment of the present invention, wherein the transmitting device is a manual rack railway. Correspondingly, the screen includes a handle part 241 and a protruded strip 242 for the convenience of pulling and moving the screen 24. The protruded strip 225 guides the movement of the protruded strip 242 of the screen 24, thereby the screen being shown or hidden. Certainly, the transmitting device can be a hydraulic transmitting device.

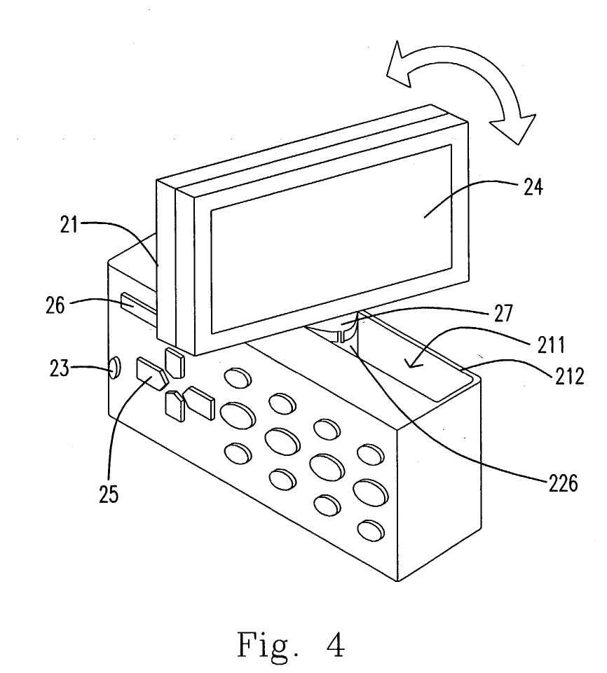

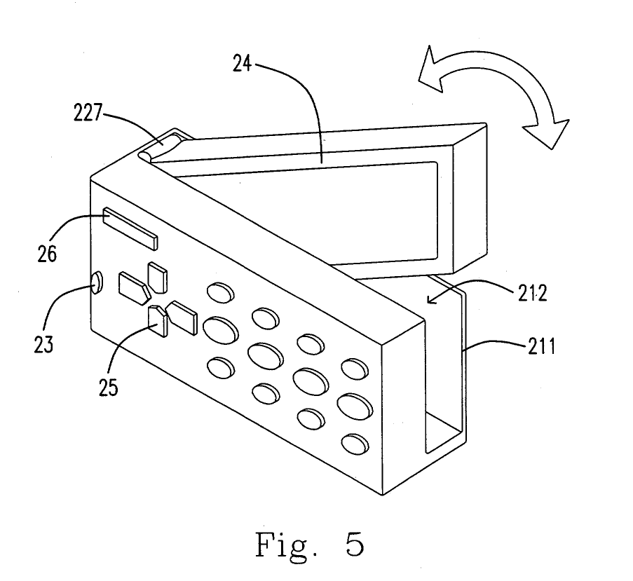

Please refer to FIG. 4, it illustrates a third preferred embodiment of the present invention. The mobile telecommunication apparatus includes the same devices as those of the above embodiment, and further includes a pivoting device 272 disposed between the transmitting device 226 and the screen 24 for rotating the screen 24 shown out of the containing space 212.

Please refer to FIG. 5, it illustrates fourth embodiment of the present invention. The mobile telecommunication apparatus includes a housing body 21 having a containing space 211 and a side opening 212, a transmitting device 227 disposed in the housing body 21; and a screen 24 connected to the transmitting device 227, wherein the screen 24 is transmitted from the containing space 211 to the side opening 212 for being shown thereby, and transmitted from the side opening 212 to the containing space 211 for being hidden thereby. Similarly, the mobile telecommunication apparatus further includes a controlling switch 23 disposed on the housing body 21 for controlling the transmitting device 227. Additionally, the side open 212 of the apparatus disposed on two adjacent sides of the housing body 21 for the convenience of showing or hiding the screen 24.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A mobile telecommunication apparatus comprising:
a housing body having a containing space and a side opening;
a transmitting device disposed in said housing body;
a controlling switch disposed on said housing body for controlling said transmitting device; and
a screen connected to said transmitting device, wherein said screen is transmitted from said containing space to said side opening for being shown on said housing body, and transmitted from said side opening to said containing space for being hidden in said housing body.

2. The mobile telecommunication apparatus according to claim 1, wherein said side opening is disposed on a long side of said housing body.

3. The mobile telecommunication apparatus according to claim 1, wherein said housing body further comprises a button set for operating said mobile telecommunication apparatus.

4. The mobile telecommunication apparatus according to claim 4, wherein said button set is a game button for operating games included in said mobile telecommunication apparatus.

5. The mobile telecommunication apparatus according to claim 1, wherein said housing body further comprises a sub-screen for showing an incoming telegram.

6. The mobile telecommunication apparatus according to claim 1, wherein said transmitting device is a hydraulic transmitting device.

7. The mobile telecommunication apparatus according to claim 6 further comprising a pivoting device disposed between said transmitting device and said screen for rotating said screen shown out of said containing space.

8. The mobile telecommunication apparatus according to claim 1, wherein said transmitting device further comprises:
a power device disposed in said housing body for providing a motive force;
a gear set connected to said power device for transmitting said motive force; and
a rack device connected to said screen and engaged with said gear for moving said screen via said motive force.

9. The mobile telecommunication apparatus according to claim 8, wherein said power device is a motor.

10. A mobile telecommunication apparatus comprising:
a housing body having a containing space and a side opening;
a transmitting device disposed in said housing body; and
a screen connected to said transmitting device, wherein said screen is transmitted from said containing space to said side opening for being shown thereby, and transmitted from said side opening to said containing space for being hidden thereby.

11. The mobile telecommunication apparatus according to claim 10 further comprising a controlling switch disposed on said housing body for controlling said transmitting device.

12. The mobile telecommunication apparatus according to claim 10, wherein said side opening is disposed on a long side of said housing body.

13. The mobile telecommunication apparatus according to claim 10, wherein said housing body further comprises a button set for operating said mobile phone.

14. The mobile telecommunication apparatus according to claim 13, wherein said button set is a game button for operating games included in said mobile telecommunication apparatus.

15. The mobile telecommunication apparatus according to claim 10, wherein said housing body further comprises a sub-screen for showing an incoming telegram.

16. The mobile telecommunication apparatus according to claim 10, wherein said transmitting device is a hydraulic transmitting device.

17. The mobile telecommunication apparatus according to claim 16 further comprising a pivoting device disposed between said transmitting device and said screen for rotating said screen to be shown out of said containing space.

18. The mobile telecommunication apparatus according to claim 10, wherein said transmitting device is a manual rack railway.

19. The mobile telecommunication apparatus according to claim 10, wherein said transmitting device further comprises:
a gear set disposed in said housing body for transmitting a motive force; and
a rack device connected to said screen and engaged with said gear for moving said screen via said motive force.

20. The mobile telecommunication apparatus according to claim 19, wherein said transmitting device further comprises a power device disposed in said housing body and engaged with said gear set for providing said motive force.

21. The mobile telecommunication apparatus according to claim 20, wherein said power device is a motor.

22. A mobile telecommunication apparatus comprising:
a displaying screen;
a housing body having a containing space for containing said display screen; and
an operating medium disposed between said displaying screen and said housing body for showing said screen on said housing body in a first instance, and hiding said displaying screen into said housing body in a second instance.
